(19) United States
(12) Patent Application Publication
(10) Pub. No.: US 2014/0357333 A1
(43) Pub. Date: Dec. 4, 2014

(54) GAMING APPARATUS FOR PRODUCING AUDIO-VISUAL SIGNALS

(71) Applicant: Dan Kevin Canobbio, Frisco, TX (US)

(72) Inventor: Dan Kevin Canobbio, Frisco, TX (US)

(73) Assignee: Dan Kevin Canobbio, Frisco, TX (US)

(21) Appl. No.: 14/292,657

(22) Filed: May 30, 2014

Related U.S. Application Data
(60) Provisional application No. 61/830,138, filed on Jun. 2, 2013.

(51) Int. Cl. A63F 13/90

(52) U.S. Cl. CPC A63F 13/08
USPC 463/7

(57) ABSTRACT

A gaming apparatus is provided for producing signals only when the play items move in a pre-defined manner. The pre-defined manner may be defined as either as play items moving above a limiting speed or the play item is moving in a pre-stored direction. The gaming apparatus includes a hollow bladder with a closeable inlet port, and at least one play item producing output signals on interaction with a user. The play item further includes a casing, an electro-mechanical sensing device for sensing the behavior of the casing, a computing unit for computing the sensed activities from the electro-mechanical sensing device and releasing a first confirmation signal, a output unit to play the first confirmation signal. The electro-mechanical sensing device includes a touch sensor and a velocity sensor.

### CROSS REFERENCE TO RELATED APPLICATION

This application claims priority to a U.S. Provisional Application No. 61/1830,138 filed on Jun. 2, 2013, the entire content of which is incorporated herein by references in its entirety.

### BACKGROUND OF THE INVENTION

1. Field of the Invention

The present invention generally relates to an interactive gaming system and more particularly relates to an interactive gaming apparatus comprising a hollow bladder and at least one play item contained inside the hollow bladder for producing an output to a particular type of motion inside the bladder.

2. Description of Related Art

Various kinds of hollow article toys are known such as ball, balloons, or any other circular or ellipsoid article. Such hollow article toys are generally filled with play items for producing audio, visual, or audio-visual output for attracting the interest of children. Such toys have been in the marketplace for a long time and are bought with great demand by parents for their young ones.

Such hollow toys or similar devices produce audio, visual or audio-visual signals when the play items are moved in any sort of motion. Thus, continuous signals become monotonous and irritating for any children, which further results in loss of interest and thus affecting the toy market considerably. There is an immediate need of creating toys more interactive to bring back the interest of children and thus benefiting the toy industry.

Therefore, there is need of a gaming system that produces signals only when the play items move above a pre-defined speed, and further in a particular direction to create interest of the user in the toy.

### SUMMARY OF THE INVENTION

In accordance with the teachings of the present invention, a gaming apparatus for producing signals only when the play items move in a pre-defined manner is provided. The pre-defined manner in the said invention includes at least one of: moving above a limiting speed; and moving in a pre-stored direction.

The gaming apparatus in the present invention produces output signals on interaction with a user. The gaming apparatus includes a hollow bladder with a closable inlet port; and at least one play item inserted inside the hollow bladder through the closable inlet port. The play item further includes a casing, an electro-mechanical sensing device, a computing unit, an output unit and an energy buffer.

The casing moves against the interior walls of the hollow bladder. The electro-mechanical sensing device attached to the casing includes one or more touch sensors and a velocity sensor. The touch sensor senses the contact of the casing with the interior walls of the hollow bladder. On sensing contact of the casing with the interior walls of the hollow bladder, the touch sensor releases a touch signal. The velocity sensor for registers the velocity of the motion of the casing and further producing a velocity signal for indicating the direction and magnitude of velocity of motion of the casing.

The computing unit stores a reference direction of velocity and a limiting magnitude of velocity. The computing unit is also connected to the electro-mechanical sensing device. The computing unit receives the touch signal and the velocity signal from the electro-mechanical sensing device.

On receiving a touch signal from the electro-mechanical sensing device, the computing unit compares the direction of velocity indicated by the velocity signal with the reference direction of velocity stored inside the computing unit. The computing unit generates a first confirmation signal in case the direction of velocity indicated by said velocity signal and reference direction of velocity stored inside the computing unit match.

The output unit is attached to the casing. The output unit generates a first output signal for the user on receiving the first confirmation signal from the computing unit. The energy buffer is attached to the computing unit, the electro-mechanical sensing device and the output unit. The output unit provides energy to the computing unit, the electro-mechanical sensing device and the output unit. The first output generated by the first output unit is at-least one of: a visual signal; an audio signal; and an audio-visual signal.

In another embodiment of the present invention, the hollow bladder of the gaming apparatus is deflatable and transparent.

In another embodiment of the present invention, the shape of the casing of the play item is at least one of: an annular disc; a spheroid; an ellipsoid; a prolate spheroid; and a cylinder.

In another embodiment of the present invention, the computing unit, on receiving the touch signal from the electro-mechanical sensing device, further generates a second confirmation signal in case the magnitude of velocity indicated by said velocity signal exceeds the limiting magnitude of velocity stored in the computing unit. The output device receives the second confirmation signal from the computing unit and further generates a second output signal for the user. The second output signal generated by the output unit is at least one of: a visual signal; an audio signal; and an audio-visual signal.

These and other features and advantages will become apparent from the following detailed description of illustrative embodiments thereof, which is to be read in connection with the accompanying drawings.

### BRIEF DESCRIPTION OF THE DRAWINGS

The disclosure will provide details in the following description of preferred embodiments with reference to the following figures wherein:

FIG. 1 illustrates a perspective view of the gaming apparatus comprising a hollow bladder and a play item, in accordance with a preferred embodiment of the invention;

FIG. 2 illustrates a block diagram of the play item in accordance with a preferred embodiment of the present invention; and

FIG. 3 illustrates a front view of the play item in accordance with an exemplary embodiment of the present invention; and

FIG. 4 illustrates a perspective view of the gaming apparatus for producing output signals on interaction with a user in accordance with an exemplary embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE DRAWINGS

While this technology is illustrated and described in a preferred embodiment, a gaming apparatus for producing audio-visual signals may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

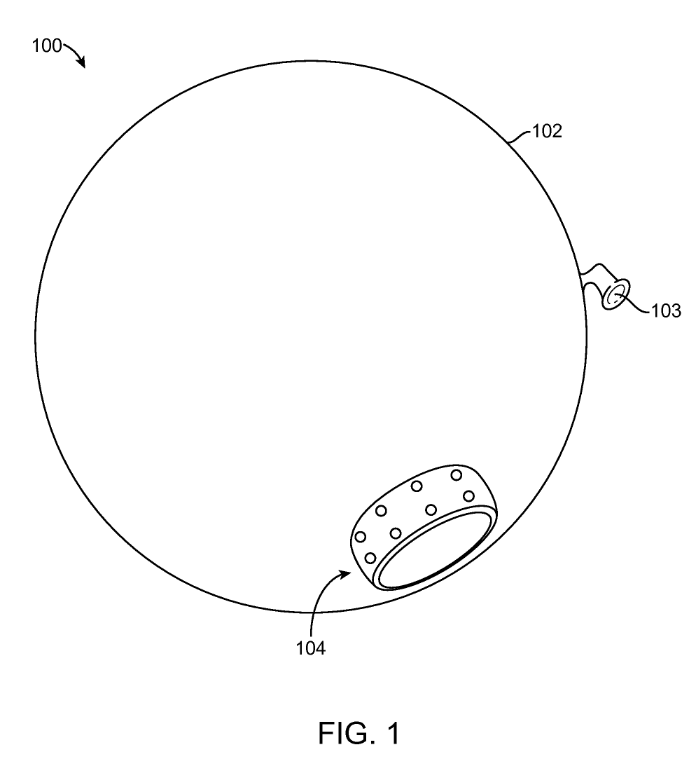

FIG. 1 illustrates a perspective view of the gaming apparatus 100 for producing output signals on interaction with a user. The gaming apparatus 100 includes a hollow bladder 102 having a closable inlet port 103; and a play item 104 inserted in said hollow bladder 102 through the closable inlet port 103, in accordance with a preferred embodiment of the invention.

Examples of the hollow bladder 102 includes but not limited to a balloon, a ball, bladder etc. In another preferred embodiment of the present invention, the hollow bladder 102 is deflatable and transparent. However, it would be readily apparent to those skilled in the art that various types of deflatable hollow bladder 102 may be envisioned without deviating from the scope of the present invention.

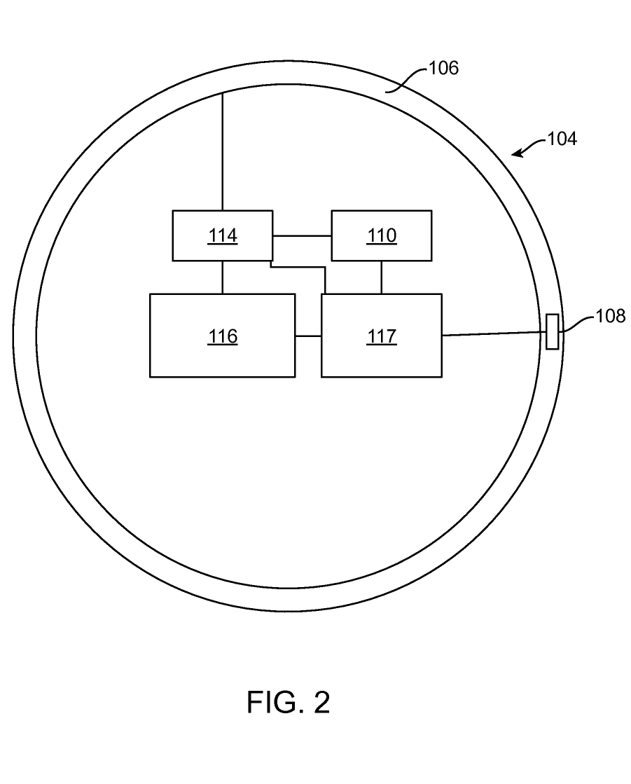

The play item 104 includes a casing, an electro-mechanical sensing device, a computing unit, an output unit, and an energy buffer. The casing moves against the interior wall of the hollow bladder 102. The electro-mechanical sensing device further includes at least one touch sensor and a velocity sensor. The output unit generates an output signal based on at least one of the direction or speed of the casing. The play item 104 and the energy buffer is explained in detail in conjunction with FIG. 2 of the present invention.

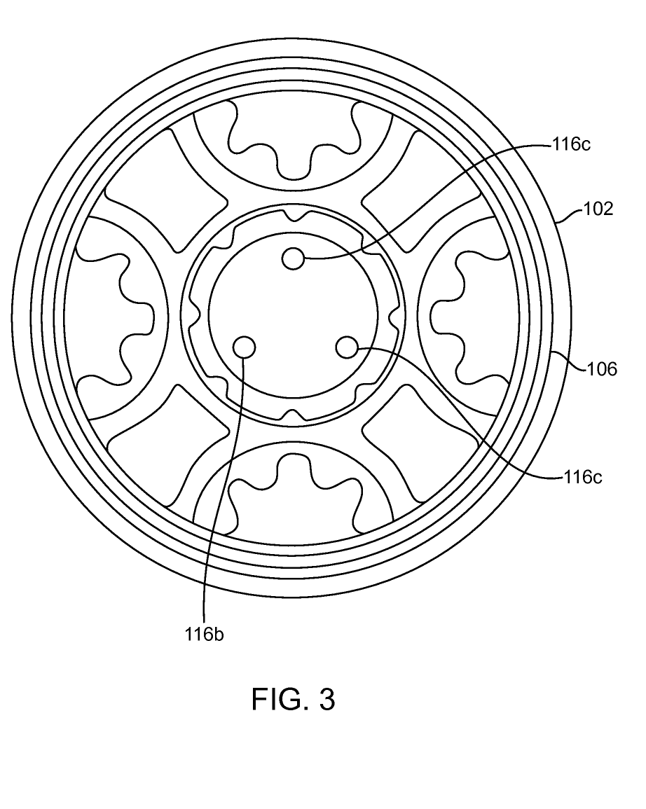

FIG. 2 illustrates a block diagram of the play item 104 in accordance with a preferred embodiment of the present invention. The casing 106 is explained in detail in conjunction with FIG. 3 of the present invention. The touch sensor 108 detects the contact of the casing 106 with the interior walls of the hollow bladder (not shown in FIG. 2) and further releasing a touch signal.

The velocity sensor 110 registers the velocity of the motion of the casing 106 in contact with the interior walls of the hollow bladder. The velocity signal indicates the direction and magnitude of the velocity of motion of the casing 106. In a preferred embodiment, the velocity sensor 110 detects the velocity of motion when the casing 106 is in contact with the inner walls of the hollow bladder (not shown in FIG. 2).

In a preferred embodiment of the present invention, the velocity of motion detected by the velocity sensor 110 is either a linear velocity of motion sensor sensing the linear velocity of motion of the casing 106, or an angular velocity sensor sensing the angular velocity of motion of the casing 106.

The computing unit 114 is attached to the casing 106 for storing a reference direction of velocity and a limiting magnitude of velocity. The computing unit 114 receives the touch signal and the velocity signal from the touch sensor 108 and the velocity sensor 110, respectively.

In a preferred embodiment of the present invention, the computing element 114 compares the direction of velocity indicated by the velocity signal with the stored reference direction and further generates a first confirmation signal in case of the direction of velocity indicated by the velocity signal and the stored reference direction of velocity matches on receiving the touch signal.

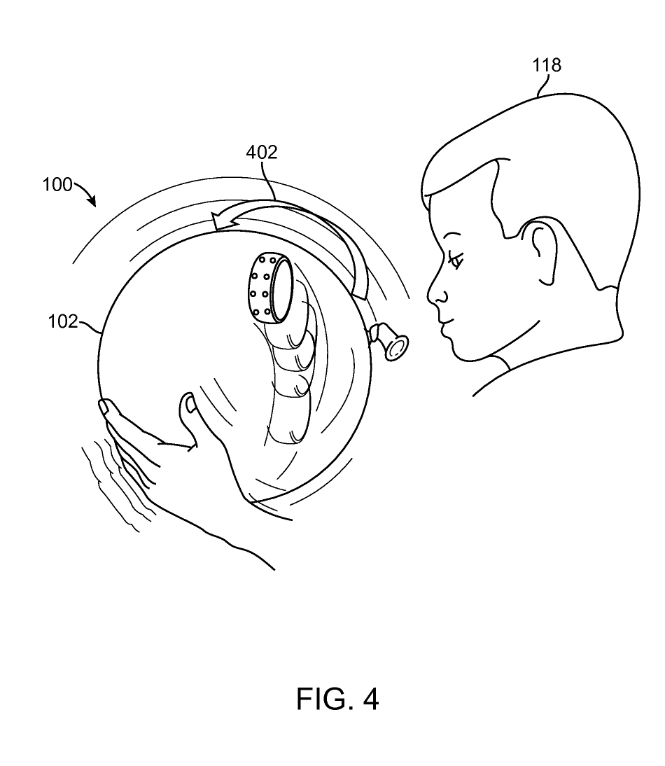

The output unit 116 is attached to the casing 106 for generating a first output signal for the user on receiving the first confirmation signal from the computing unit 114. An example of the play item 104 wherein the direction of velocity and stored reference direction of velocity for generating first confirmation signal matches is explained in detail in conjunction with FIG. 4 of the present invention.

The energy buffer 117 provides energy to the computing unit 114, the touch sensor 108, the velocity sensor 110 and the output unit 116. Examples of energy buffer 117 includes but not limited to battery. It would be readily apparent to those skilled in the art that various other types of energy buffer 117 may be used without deviating from the scope of the present invention.

In another preferred embodiment of the present invention, the computing element 114 generates a second confirmation signal in case the magnitude of velocity indicated by the velocity signal exceeds the stored limiting magnitude of velocity on receiving the touch signal from the touch sensor 108. An example of the play item 104 wherein the magnitude of velocity exceeds the stored limiting magnitude of velocity is explained in detail in conjunction with FIG. 4 of the present invention.

In another embodiment of the present invention, the output unit 116 generates a second output signal on receiving the second confirmation signal from the computing element 114. Examples of the first output signal and the second output signal includes but not limited to audio signals, video signals or audio-video signals etc.

FIG. 3 illustrates a cross-sectional front view of the game apparatus 100 in accordance with an exemplary embodiment of the present invention. The shape of casing 106 is configured for creating smooth movement against the inside walls of the hollow bladder 102. Examples of the shape of the casing 106 includes but not limited to annular disc, spherical casing, a spheroid, an ellipsoid, a prolate spheroid, a ring-like casing, a cylinder and a flat casing. However, it would be readily apparent to those skilled in the art that various other shapes of the casing 106 may also be envisioned without deviating from the scope of the present invention.

Further in another preferred embodiment of the present invention, FIG. 3 displays one or more output units 116 such as 116a, 116b and 116c attached to the casing 106. Examples of the output unit 116 includes but not limited to LED, speakers, transducers. It would be readily apparent to those skilled in the art that various other forms of output units 116 may be envisioned for producing audio, video or audio-video signals without deviating from the scope of the present invention.

FIG. 4 illustrates a perspective view of the gaming apparatus 100 for producing output signals on interaction with a user 118. In the present embodiment, the user 118 is making the play item 104 to move inside the hollow bladder 102 to play a game. In an exemplary embodiment, the reference direction of velocity is anti-clockwise direction.

Thus, as shown in FIG. 4 the arrow 402 indicates the direction of velocity i.e. anti-clockwise. Herein, both the reference direction of velocity and the direction of velocity are anti-clockwise and thus computing element generates a confirmation signal for the output unit to generate output signal.

Further in another exemplary embodiment of the present invention, the limiting magnitude of velocity is 2 m/h and the magnitude of velocity indicated by the velocity sensor is 3 m/h, thus the magnitude of velocity exceeds the limiting magnitude of velocity. This results in generation of the confirmation signal for the output unit to generate the output signal.

The present invention offers various advantages such as creating highly interactive toy based on motion created by the user. The gaming apparatus of the present invention helps in increasing the concentration power of the user. The present invention generates light and sound output to attract the interest of the user.

1: A gaming apparatus for producing output signals on interaction with a user, said gaming apparatus comprising:
a hollow bladder having a closable inlet port; and
at least one play item inserted in said hollow bladder through said closable inlet port, said play item comprising:
a casing to move against the interior walls of said hollow bladder;
an electro-mechanical sensing device attached to said casing, said electro-mechanical sensing device comprising:
one or more touch sensors for sensing the contact of said casing with the interior walls of said hollow bladder and further releasing a touch signal; and
a velocity sensor for registering the velocity of the motion of said casing in contact with the interior walls of said hollow bladder and further producing a velocity signal for indicating the direction and magnitude of velocity of motion of said casing;
a computing unit attached to said casing for storing a reference direction of velocity and a limiting magnitude of velocity, said computing unit further connected to said electro-mechanical sensing device for:
receiving said touch signal and said velocity signal from said electro-mechanical sensing device;
comparing the direction of velocity indicated by said velocity signal with said stored reference direction; and
generating a first confirmation signal in case of said direction of velocity indicated by said velocity signal and said stored reference direction of velocity matches on receiving said touch signal; and
an output unit attached to said casing for generating a first output signal for the user on receiving said first confirmation signal from said computing unit; and
an energy buffer attached to said casing for providing energy to said computing unit, said electro-mechanical sensing device and said output unit.

2: The gaming apparatus of claim 1 wherein said hollow bladder is deflatable.

3: The gaming apparatus of claim 1 wherein said hollow bladder is transparent.

4: The gaming apparatus of claim 1 wherein the shape of said casing is at least one of: an annular disc; a spheroid; an ellipsoid; a prolate spheroid and a cylinder.

5: The gaming apparatus of claim 1 wherein said first output signal is at least one of: a visual signal; an audio signal; and an audio-visual signal.

6: The gaming apparatus of claim 1 wherein said computing unit further generates a second confirmation signal in case the magnitude of velocity indicated by said velocity signal exceeds said stored limiting magnitude of velocity on receiving said touch signal; wherein said output unit receives said second confirmation signal from said computing unit to further generate a second output signal for the user.

7: The gaming apparatus of claim 6 wherein said second output signal is at least one of: a visual signal; an audio signal; and an audio-visual signal.

8: A gaming apparatus for producing output signals on interaction with a user, said gaming apparatus comprising:
a hollow bladder having a closable inlet port;
at least one play item inserted in said hollow bladder through said closable inlet port, said play item comprising:
a casing to move against the interior walls of said hollow bladder;
an electro-mechanical sensing device attached to said casing, said electro-mechanical sensing device comprising:
a touch sensor for sensing the contact of said casing with the interior walls of said hollow bladder and further releasing a touch signal; and
a velocity sensor for registering the velocity of the motion of said casing in contact with the interior walls of said hollow bladder and further producing a velocity signal for indicating the direction and magnitude of velocity of motion of said casing;
a computing unit attached to said casing for storing a reference direction of velocity and a limiting magnitude of velocity, said computing unit further connected to said electro-mechanical sensing device for:
receiving said touch signal and said velocity signal from said electro-mechanical sensing device;
comparing the magnitude of velocity indicated by said velocity signal with said stored limiting magnitude of velocity; and
generating a second confirmation signal in case of the magnitude of velocity indicated by said velocity signal exceeds said stored limited magnitude of velocity on receiving said touch signal; and
an output unit attached to said casing to generate a second output signal for the user on receiving said second confirmation signal received from said computing unit; and
an energy buffer attached to said casing for providing energy to said computing unit, said electro-mechanical sensing device and said output unit.

9: The gaming apparatus of claim 8 wherein said hollow bladder is deflatable.

10: The gaming apparatus of claim 8 wherein said hollow bladder is transparent.

11: The gaming apparatus of claim 8 wherein the shape of said casing is at least one of: an annular disc; a spheroid; an ellipsoid; a prolate spheroid; and a cylinder.

12: The gaming apparatus of claim 8 wherein said second output signal produces at least one of: a visual signal; an audio signal; and an audio-visual signal.

13: The gaming apparatus of claim 8 wherein said computing element compares the direction of velocity indicated by said velocity signal with said stored reference direction of velocity, said computing element further generates a first confirmation signal in case of the direction of velocity indicated by said velocity signal matches said stored reference direction of velocity on receiving said touch signal; wherein said output unit receives said first confirmation signal from said computing unit to further generate a first output signal for the user.

14: The gaming apparatus of claim 13 wherein said first output signal is at least one of: a visual signal; an audio signal; and an audio-visual signal.
